(19) United States
(12) Patent Application Publication
(10) Pub. No.: US 2018/0321407 A1
(43) Pub. Date: Nov. 8, 2018

(54) MARINE SURVEY APPARATUS, SYSTEM, AND METHOD WITH A RIGID STRUCTURE

(71) Applicant: PGS Geophysical AS, Oslo (NO)

(72) Inventors: Karl Petter Elvestad, Oslo (NO); Thomas M. Hvesser, Oslo (NO)

(73) Assignee: PGS Geophysical AS, Oslo (NO)

(21) Appl. No.: 15/967,716

(22) Filed: May 1, 2018

Related U.S. Application Data
(60) Provisional application No. 62/501,310, filed on May 4, 2017.

(51) Int. Cl. G01V 1/38

(52) U.S. Cl. CPC G01V 1/3826

(57) ABSTRACT

Seismic source element modules can each include a seismic source element. Spacer modules can each have a hydrofoil shape. A first end of the spacer modules can be coupled to a respective first one of the seismic source element modules. A second end of the spacer modules can be coupled to a respective second one of the seismic source element modules. The source element modules and the spacer modules can collectively form a rigid structure.

### CROSS-REFERENCE TO RELATED APPLICATIONS

This application claims priority to U.S. Provisional Application 62/501,310, filed May 4, 2017, which is incorporated by reference.

### BACKGROUND

In the past few decades, the petroleum industry has invested heavily in the development of marine seismic survey techniques that yield knowledge of subterranean formations beneath a body of water in order to find and extract valuable mineral resources, such as oil. High-resolution images of a subterranean formation are helpful for quantitative interpretation and improved reservoir monitoring. For a typical marine seismic survey, a marine survey vessel tows one or more sources below the water surface and over a subterranean formation to be surveyed for mineral deposits. Receivers may be located on or near the seafloor, on one or more streamers towed by the marine survey vessel, or on one or more streamers towed by another vessel. The marine survey vessel typically contains marine survey equipment, such as navigation control, source control, receiver control, and recording equipment. The source control may cause the one or more sources, which can be air guns, marine vibrators, electromagnetic sources, etc., to produce signals at selected times. For example, each signal is essentially a wave called a wavefield that travels down through the water and into the subterranean formation. At each interface between different types of rock, a portion of the wavefield may be refracted, and another portion may be reflected, which may include some scattering, back toward the body of water to propagate toward the water surface. The receivers thereby measure a wavefield that was initiated by the actuation of the source. In another example, an electric current is injected into the water and the resulting electromagnetic field in the water is measured by the receivers. The resulting electromagnetic field can be indicative of mineral deposits.

### BRIEF DESCRIPTION OF THE DRAWINGS

FIG. 1 is an elevation or xz-plane view of an example of marine surveying in which signals are emitted by a seismic source for recording by marine survey receivers.

FIG. 2 is an elevation or xz-plane view of an example of marine surveying in which signals are emitted by plurality of seismic source elements.

FIG. 3 is a top or yx-plane view of an example of marine surveying in which signals are emitted by a plurality of seismic source elements.

FIG. 4 is an xz-plane view of an example of a marine survey system in a vertical orientation.

FIG. 5 is an xz-plane view of an example of a marine survey system in an approximately horizontal orientation.

FIG. 6 is a perspective view of an example of a portion of a rigid structure.

FIG. 7 is a cross section of an example of a spacer module with a hinged trailing edge.

FIG. 8A is a cross section of an example of a spacer module with tow line attachment points.

FIG. 8B is a cross section of an example of a spacer module with a tow line attachment point.

FIG. 9 is a flow chart illustrating an example of a method for deploying a marine survey system.

FIG. 10 is a flow chart illustrating an example of a method for recovering a marine survey system.

### DETAILED DESCRIPTION

This disclosure is related generally to the field of marine surveying. Marine surveying can include, for example, seismic surveying or electromagnetic surveying, among others. During marine surveying, one or more source elements are used to generate wavefields, such as acoustic signals, and receivers (towed and/or ocean bottom) receive energy generated by the source elements and affected by the interaction with a subsurface formation. The receivers thereby collect survey data, which can be useful in the discovery and/or extraction of hydrocarbons from subsurface formations. As used herein, a “seismic source element” is a single source device, such as an air gun or marine vibrator. A “source unit” is a plurality of seismic source elements that are actuated together. A “source string” is a plurality of seismic source elements that share a common actuation delivery, such as air for air guns or electricity for electromagnetic sources. A “source array” is a plurality of seismic source elements or a plurality of source units that may be actuated separately. As used herein, a “seismic source” refers to one or more single source devices, arranged as a seismic source element, source unit, or source array.

It can beneficial to have multiple depth seismic source elements (multiple seismic source elements at different depths). For example, such a setup can be beneficial for marine surveys that include irregular and/or random source actuation. However, some previous approaches to multiple depth seismic source elements have not been practical. In some previous approaches, the depth variations within a source string, which may be referred to as a string or sub-string, are limited in quantity of seismic source elements, distance, or both. In many instances, the seismic source elements associated with a source string may be at the same depth. In a marine survey using more than one source string, different source strings can be at different depths. However the seismic source elements associated with each source string may be arranged inline, such that there is little or no variation in depth between the seismic source elements of the source string. Challenges that may arise from such a setup may include signature issues, which may be caused by air curtains from the deepest seismic source element affecting the signature of seismic source elements actuated above the deepest seismic source element.

At least one embodiment of the present disclosure can overcome these challenges by including a plurality of seismic source elements in an inline vertical orientation in contrast to an inline horizontal orientation of some previous approaches. At least one embodiment includes a multiple depth source string with the seismic source elements oriented on a single vertical axis, where each seismic source element is at the same position in the horizontal plane, regardless of the depth of the seismic source element.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

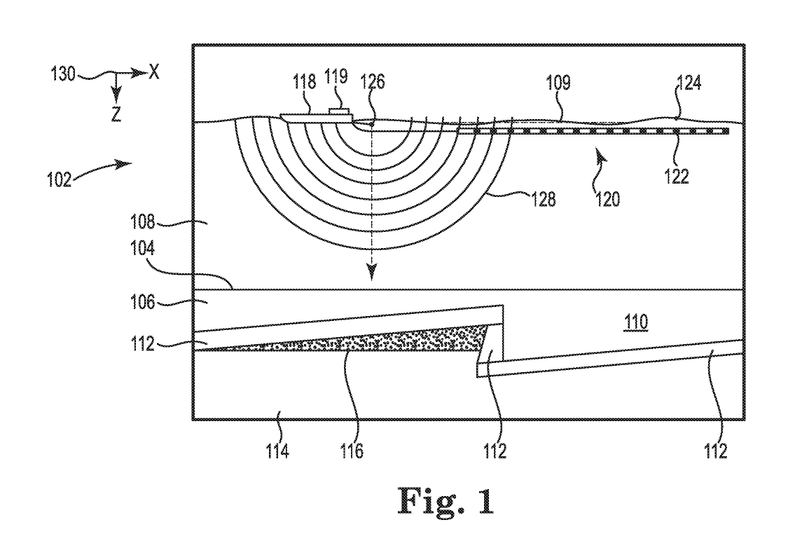

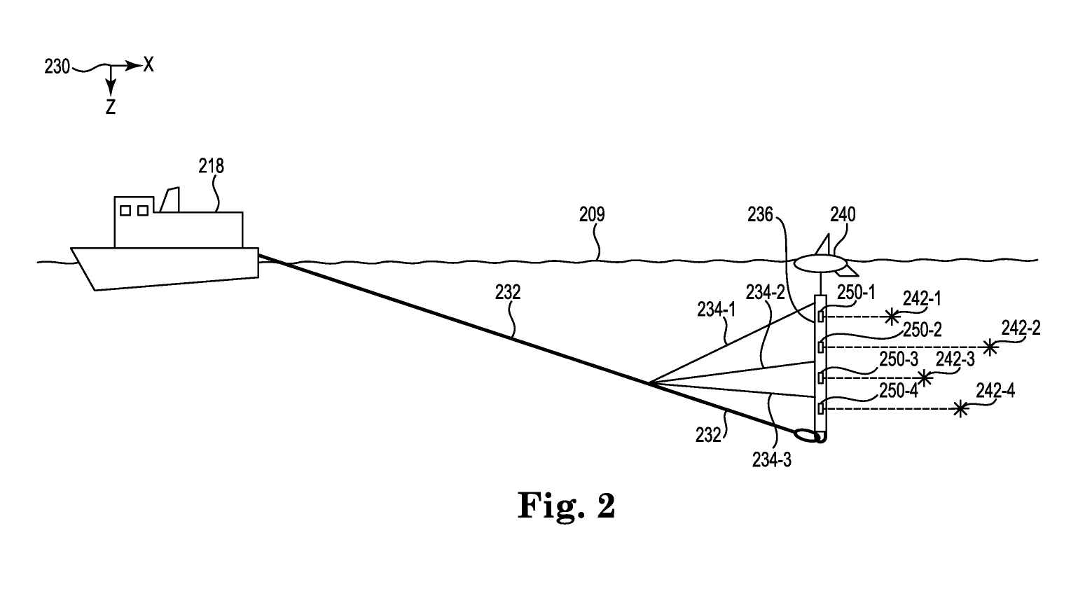

The figures herein follow a numbering convention in which the first digit or digits correspond to the drawing figure number and the remaining digits identify an element or component in the drawing. Similar elements or components between different figures may be identified by the use of similar digits. For example, 118 may reference element “18” in FIG. 1, and a similar element may be referenced as 218 in FIG. 2. Analogous elements within a Figure may be referenced with a hyphen and extra numeral or letter. See, for example, elements 250-1, 250-2, 250-3, and 250-4 in FIG. 2. Such analogous elements may be generally referenced without the hyphen and extra numeral or letter. For example, elements 250-1, 250-2, 250-3, and 250-4 may be collectively referenced as 250. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

FIG. 1 illustrates an elevation or xz-plane 130 view of an example of marine surveying in which signals are emitted by a seismic source 126 for recording by marine survey receivers 122. The recording can be used for processing and analysis in order to help characterize the structures and distributions of features and materials underlying the surface of the earth. FIG. 1 shows a domain volume 102 of the earth's surface comprising a subsurface volume 106 of sediment and rock below the surface 104 of the earth that, in turn, underlies a fluid volume 108 of water having a sea surface 109 such as in an ocean, an inlet or bay, or a large freshwater lake. The domain volume 102 shown in FIG. 1 represents an example experimental domain for a class of marine surveys. FIG. 1 illustrates a first sediment layer 110, an uplifted rock layer 112, second, underlying rock layer 114, and hydrocarbon-saturated layer 116. One or more elements of the subsurface volume 106, such as the first sediment layer 110 and the first uplifted rock layer 112, can be an overburden for the hydrocarbon-saturated layer 116. In some instances, the overburden may include salt.

FIG. 1 shows an example of a marine survey vessel 118 equipped to carry out marine surveys. In particular, the marine survey vessel 118 can tow one or more streamers 120 (shown as one streamer for ease of illustration) generally located below the sea surface 109. The streamers 120 can be long cables containing power and data-transmission lines (e.g., electrical, optical fiber, etc.) to which marine survey receivers may be coupled. In one type of marine survey, each marine survey receiver, such as the marine survey receiver 122 represented by the shaded disk in FIG. 1, comprises a pair of sensors including a geophone that detects particle displacement within the water by detecting particle motion variation, such as velocities or accelerations, and/or a hydrophone that detects variations in pressure. In one type of marine survey, each marine survey receiver, such as marine survey receiver 122, comprises an electromagnetic receiver that detects electromagnetic energy within the water. The streamers 120 and the marine survey vessel 118 can include sensing electronics and data-processing facilities that allow marine survey receiver readings to be correlated with absolute positions on the sea surface and absolute three-dimensional positions with respect to a three-dimensional coordinate system. In FIG. 1, the marine survey receivers along the streamers are shown to lie below the sea surface 109, with the marine survey receiver positions correlated with overlying surface positions, such as a surface position 124 correlated with the position of marine survey receiver 122.

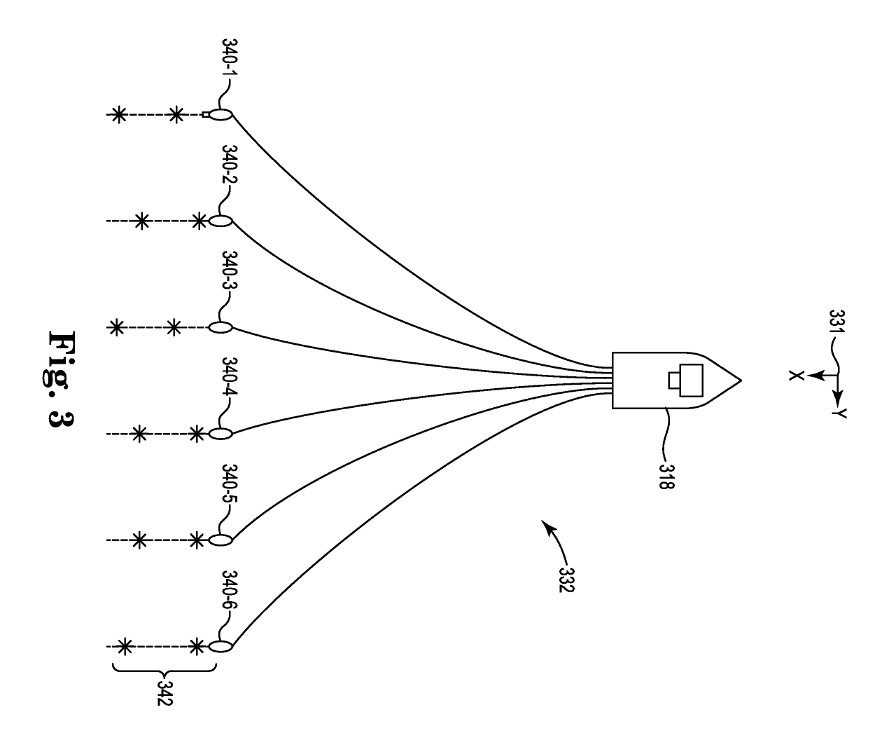

The marine survey vessel 118 can also tow one or more seismic sources 126 that produce signals as the marine survey vessel 118 and streamers 120 move across the sea surface 109. Seismic sources 126 and/or streamers 120 may also be towed by other vessels, or may be otherwise disposed in fluid volume 108. For example, marine survey receivers may be located on ocean bottom cables or nodes fixed at or near the surface 104, and seismic sources 126 may also be disposed in a nearly-fixed or fixed configuration. For the sake of efficiency, illustrations and descriptions herein show marine survey receivers located on streamers, but it should be understood that references to marine survey receivers located on a “streamer” or “cable” should be read to refer equally to marine survey receivers located on a towed streamer, an ocean bottom receiver cable, and/or an array of nodes. Although illustrated as a point, the seismic source 126 can represent a source string, such as illustrated in FIG. 2, or a source array, such as is illustrated in FIG. 3. The marine survey vessel 118 can include a controller 119. For example, the controller 119 can be coupled to the seismic source 126 and configured to control deployment and recovery of the seismic source 126 as described herein.

FIG. 1 shows source energy illustrated as an expanding, spherical signal, illustrated as semicircles of increasing radius centered at the seismic source 126, representing a down-going wavefield 128, following a signal emitted by the seismic source 126. The down-going wavefield 128 is, in effect, shown in a vertical plane cross section in FIG. 1. The outward and downward expanding down-going wavefield 128 may eventually reach the surface 104, at which point the outward and downward expanding down-going wavefield 128 may partially scatter, may partially reflect back toward the streamers 120, and may partially refract downward into the subsurface volume 106, becoming elastic signals within the subsurface volume 106.

FIG. 2 is an elevation or xz-plane 230 view of an example of marine surveying in which signals are emitted by plurality of seismic source elements 250. The marine survey vessel 218 is shown towing an umbilical 232, which is coupled to a rigid structure 236. The rigid structure 236 is also coupled to a plurality of tow lines 234, which are also coupled to the umbilical 232. Although three tow lines 234-1, 234-2, 234-3 are illustrated, embodiments are not limited to any particular quantity of tow lines 234. The rigid structure is also coupled to a support float 240 that floats along the surface 209 while the rigid structure 236 is towed by the marine survey vessel 218.

The rigid structure 236 includes a plurality of seismic source elements 250 oriented along a vertical axis (in the z-direction). Although four seismic source elements 250-1, 250-2, 250-3, 250-4 are illustrated, embodiments are not limited to any particular quantity of seismic source elements 250. Having seismic source elements 250-1 arranged in a vertical structure can allow for more numerous nearfield receivers (not specifically illustrated), for example, to receive a direct arrival signal from the seismic source elements 250-1. In at least one embodiment, the rigid structure 236 can include only one seismic source element 250. The seismic source elements 250 can be electromagnetic, impulsive, non-impulsive, or other types of seismic source elements suitable for use in marine surveying. Collectively, the seismic source elements 250 included in the rigid structure 236 may be referred to as a source string. Actuation points 242 are illustrated for each of the seismic source elements 250, which are moving in an in-line direction as towed by the marine survey vessel 218. Specifically, a first actuation point 242-1 is illustrated for a first seismic source element 250-1, a second actuation point 242-2 is illustrated for a second seismic source element 250-2, a third actuation point 242-3 is illustrated for a third seismic source element 250-3, and a fourth actuation point 242-4 is illustrated for a fourth seismic source element 250-4. The actuation points 242 are in different locations both vertically (in the z-direction) and in-line (in the x-direction). The vertical position of each actuation point 242 corresponds to the vertical position of each seismic source element 250. The horizontal position of each actuation point 242 corresponds to a time when the corresponding seismic source element 250 for each actuation point 242 was actuated and to a position that the corresponding seismic source element 250 was in when it was actuated. As can be observed, the actuation points 242 for the different seismic source elements 250 are varied such that they do not align vertically because they were in different positions when actuated. Such varied actuation can help to reduce interference in the signal generated by the actuation of a particular seismic source element (e.g., seismic source element 250-1) from the actuation of a different seismic source element (e.g., seismic source element 250-2).

FIG. 3 is a top or yx-plane 331 view of an example of marine surveying in which signals are emitted by a plurality of seismic source elements. A marine survey vessel 318 can tow one or more rigid structures, such as the rigid structure 236 illustrated in FIG. 2. In the view presented in FIG. 3, a plurality of support floats 340 are visible. Although six support floats 340-1, 340-2, 340-3, 340-4, 340-5, 340-6 are illustrated, embodiments are not limited to any particular quantity of support floats. Although not visible in FIG. 3, the support floats 340 are coupled to and located vertically above corresponding rigid structures. A plurality of umbilicals 332 are illustrated. Although, based on the perspective of FIG. 3, the umbilicals 332 may appear to be coupled to the support floats 340, the umbilicals 332 are coupled to lower ends of the rigid structures (as illustrated in FIG. 2).

The rigid structures coupled to the support floats 340 can include respective source elements. Collectively, the source elements included in the rigid structures coupled to the support floats 340 may be referred to as a source array. A plurality of actuation points 342 for different source elements are illustrated behind the support floats 340 in the in-line direction. FIG. 3 illustrates that the actuation points can be varied cross-line (in the y-direction) in addition to vertically (in the z-direction as illustrated in FIG. 2) and in-line (in the x-direction as illustrated in FIG. 2). The source elements arranged in the different rigid structures can be at a same depth or a different depth for different rigid structures in the source array. The different depths can be achieved by arranging the source elements differently within the rigid structures, by coupling the rigid structures at different depths below the support floats 340, or both.

Varied actuation of source elements as illustrated and described with respect to FIGS. 2-3 can be beneficial in providing signatures for the actuations of each source element with lesser interference from actuations of other source elements as compared to previous approaches. The ability to vary actuation of source elements in depth, in addition to in-line and cross-line can provide enhanced clarity of signatures. As described in more detail with respect to the following figures, at least one embodiment of the present disclosure can provide source elements in a source string or source array with varied depth while providing fine control over the position of the source elements in the source string or array. For example such fine control over the position of the source elements can be achieved through the use of the rigid structure described herein.

A plurality of source strings, each in a respective inline vertical orientation, can be used to form a source array. A respective umbilical 332 coupled to the source elements of each source string (e.g. via air cables as described herein) can have a smaller diameter than that of some previous approaches because a greater number of smaller umbilicals 332 can be used with a wider spread than some previous approaches. The diameter of the umbilical can be a function of the quantity of and volume of the source elements in each source string such that fewer source elements or source elements with a smaller volume can allow the diameter of the umbilical to be reduced.

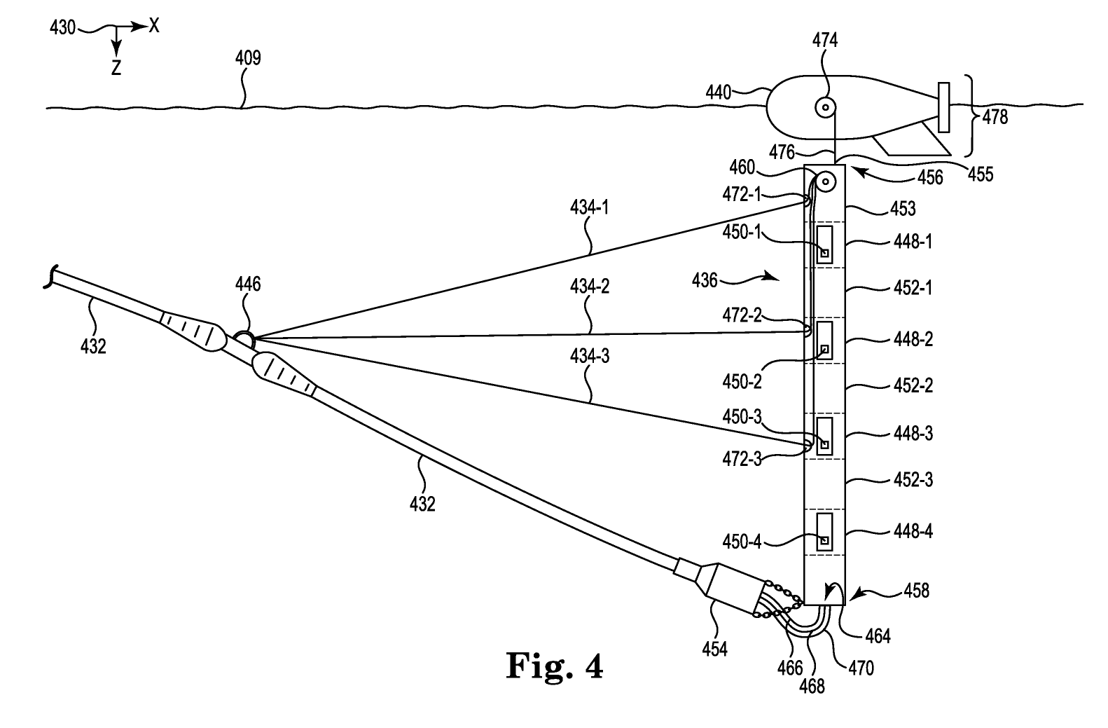

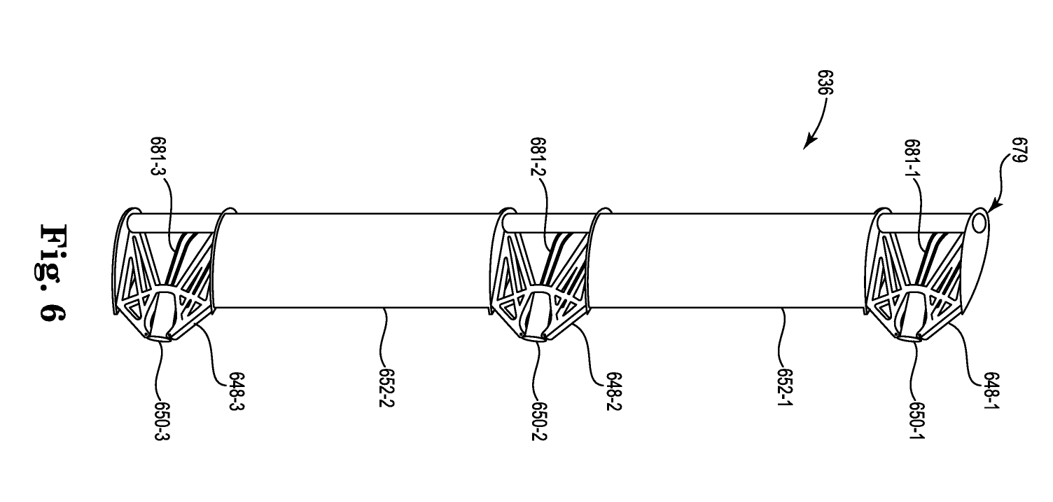

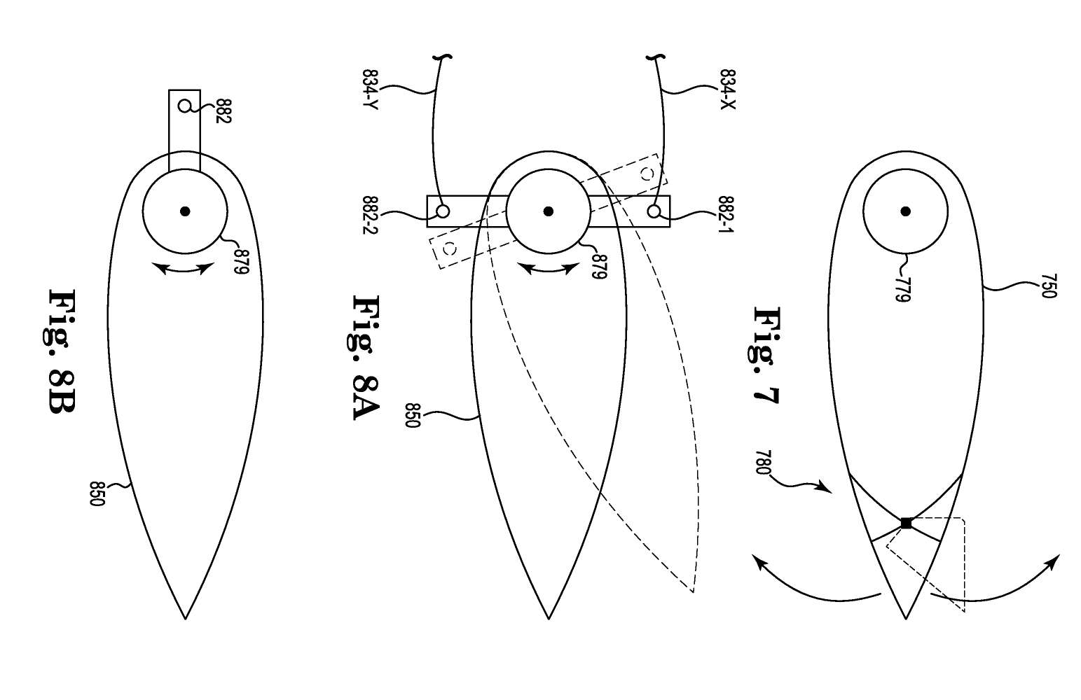

FIG. 4 is an xz-plane 430 view of an example of a marine survey system in a vertical orientation. The view presented in FIG. 4 shows more detail than that of FIG. 2 for the marine survey system. The marine survey system can include a rigid structure 436 including a plurality of spacer modules 452 each having a hydrofoil shape and a plurality of seismic source modules 448 coupled to the spacer modules 452. The hydrofoil shape is illustrated in more detail in FIGS. 7-8, which illustrate cross sections of the spacer modules 452. The seismic source modules 448 may have a general hydrofoil shape (cross section). However the shape of the seismic source element modules 448 may deviate from a smooth hydrofoil as illustrated in more detail in FIG. 6. Collectively, the spacer modules 452 and seismic source element modules 448, which can be rigid, can form the rigid structure 436.

The marine survey system can include a support float 440 coupled to a first end 456 of the rigid structure 436. The support float 440 can include a depth control device 474 coupled to the rigid structure 436 and configured to control a depth of the rigid structure 436. For example, the depth control device can be a winch configured to retract and extend a line 476 coupled to the rigid structure 436 to raise and lower the rigid structure 436. The support float 440 can include a position control device 478, such as a rudder, which can be operated to steer the support float 440 and thus the rigid structure 436.

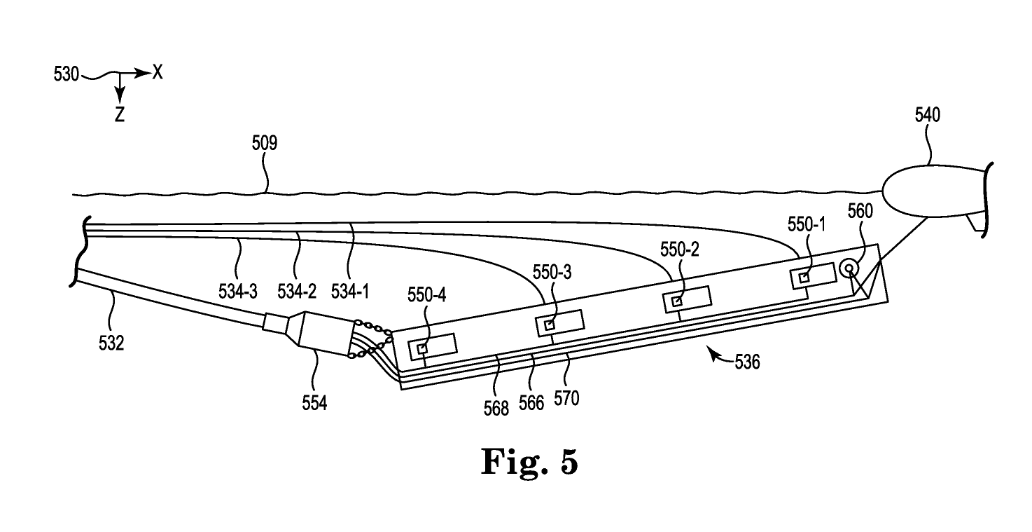

The marine survey system can include an umbilical 432 coupled to the rigid structure 436. For example, FIG. 4 illustrates the umbilical 432 being coupled to a second end 458 of the rigid structure 436, however embodiments are not limited to the umbilical being coupled to the second end 458 of the rigid structure 436 as it may be coupled to a different location on the rigid structure 436. The umbilical 432 can include a bridle 446 coupled to the plurality of tow lines 434. The umbilical 432 can include a power cable 466 coupled to the tow line winch 460. The coupling of the power cable 466 to the tow line winch 460 is illustrated more clearly in FIG. 5. The power cable 466 can provide power from the marine survey vessel to the tow line winch 460 via the umbilical 432. The power cable 466 or a different power cable from the umbilical 432 can be coupled to and configured to provide power to the depth control device 474 on the support float 440. The power cable 466 or a different power cable from the umbilical 432 can be coupled to and configured to provide power to the position control device 478. According to some previous approaches, power for support floats may be provided onboard the float via power sources such as batteries, solar panels, and/or ram turbine (water drag) generators.

The marine survey system can include a tow line winch 460 coupled to the rigid structure 436 and to a plurality of tow lines 434-1, 434-2, 434-3 such that operation of the tow line winch 460 changes an amount by which the plurality of tow lines 434 are extended to change an orientation of the rigid structure between vertical (as illustrated in FIG. 4) and approximately horizontal (as illustrated in FIG. 5). The tow lines 434 can be coupled to the tow line winch 460 through a corresponding plurality of openings 472-1, 472-2, 472-3 in the rigid structure 436. FIG. 4 includes more detail showing the coupling between the tow lines 434 and the tow line winch 460, while FIG. 5 shows less detail regarding the tow lines 434, but more detail regarding the power cable 466, an air cable 468, and a communication cable 470, from the umbilical 432.

The tow line winch 460 and the tow lines 434 can be configured such that operation of the tow line winch 460 to increase the amount by which the tow lines 434 are extended changes the orientation of the rigid structure 436 away from vertical and toward horizontal. As the tow lines 434 are unwound and extended from the tow line winch 460 during towing, drag on the support float 440 will tend to pull the support float 440 farther from the marine survey vessel. If the umbilical 432 is held at a constant length by the marine survey vessel, the support float will move away from the marine survey vessel in the in-line direction to the right (as illustrated in FIG. 4), the tow lines 434 will extend, and the rigid structure 436 will move toward a more horizontal orientation (illustrated in FIG. 5). Conversely, the tow line winch 460 and the tow lines 434 can be configured such that operation of the tow line winch 460 to decrease the amount by which the tow lines 434 are extended changes the orientation of the rigid structure 436 away from horizontal and toward vertical. Retracting the tow lines 434 effectively pulls the support float 440 closer to the marine survey vessel and pulls the rigid structure 436 into a more vertical orientation. An end 454 of the umbilical 432 coupled to the second end 458 of the rigid structure 436 can be sufficiently heavy to urge the second end 458 of the rigid structure 436 to remain vertically below, although not necessarily directly below, the support float 440 while being towed at marine survey speeds in cases of deployment and recovery.

Although three spacer modules 452-1, 452-2, 452-3 are illustrated and four seismic source modules 448-1, 448-2, 448-3, 448-4, embodiments are not limited to any particular quantity of either. The seismic source element modules 448 can each include a respective seismic source element 450-1, 450-2, 450-3, 450-4, such as an air gun. Although the spacer modules 452 and seismic source element modules 448 are illustrated as being coupled within the rigid structure 436 in an alternating fashion, in at least one embodiment, two or more spacer modules 452 can be directly connected to each other or two or more seismic source element modules 448 can be directly connected to each other. The tow line winch 460 can be included in a tow line winch module 453 coupled to the rigid structure 436, such as at the first n end 456 of the rigid structure 436. Although not specifically illustrated, the tow line winch module 453 can be coupled to the second end 458 of the rigid structure 436 or somewhere between the first end 456 and the second end 458 of the rigid structure 436. The end of the rigid structure 436, such as the tow line winch module 453, a last seismic source element module 448, or a last spacer module 450 coupled to the rigid structure 436, can include a support attachment point 455 configured to be coupled to a line 476 from the support float 440. An opposite end 458 of the rigid structure 436 can be configured to be coupled to the umbilical 432 from a marine survey vessel. The opposite end 458 can include an opening 464 configured to receive cables, such as the power cable 466, the air cable 468, and the communication cable 470, from the umbilical 432.

FIG. 5 is an xz-plane 530 view of an example of a marine survey system in an approximately horizontal orientation. As used herein, “approximately horizontal” means that the rigid structure 536 is more horizontal than vertical, although the rigid structure may not be exactly parallel to the surface 509. The marine survey system can include a tow line winch 560 coupled to the rigid structure 536 and to a plurality of tow lines 534-1, 534-2, 534-3 such that operation of the tow line winch 560 changes an amount by which the plurality of tow lines 534 are extended to change an orientation of the rigid structure between vertical (as illustrated in FIG. 4) and approximately horizontal (as illustrated in FIG. 5). The tow line winch 560 and the tow lines 534 can be configured such that operation of the tow line winch 560 to increase the amount by which the tow lines 534 are extended changes the orientation of the rigid structure 536 away from vertical and toward horizontal. As the tow lines 534 are unwound and extended from the tow line winch 560 during towing, drag on the support float 540 at the surface 509 will tend to pull the support float 540 farther from the marine survey vessel. If the umbilical 532 is held at a constant length by the marine survey vessel, the support float will move away from the marine survey vessel (to the right as illustrated in FIG. 5), the tow lines 534 will extend, and the rigid structure 536 will move toward a more horizontal orientation as illustrated in FIG. 5. The tow lines 534 can be extended until they are slack and all of the tension of the marine survey system is carried through the umbilical 532. The tow line winch 560 and the tow lines 534 can be configured such that operation of the tow line winch 560 to decrease the amount by which the tow lines 534 are extended changes the orientation of the rigid structure 536 away from horizontal and toward vertical. Retracting the tow lines 534 effectively pulls the support float 540 closer to the marine survey vessel and pulls the rigid structure 536 into a more vertical orientation.

Illustrated near an end 554 of the umbilical 532 coupled to the rigid structure 536 are a power cable 566, an air cable 568, and a communication cable 570. The air cable 568 is coupled to a plurality of seismic source elements 550-1, 550-2, 550-3, 550-4 in the plurality of seismic source element modules (not specifically labeled in FIG. 5). The air cable 568 can provide air from the marine survey vessel to the seismic source elements 550 (e.g., air guns) for actuation thereof. The power cable 566 can be coupled to the tow line winch 560. The power cable 566 or a different power cable from the umbilical 532 (not specifically illustrated) can be coupled to and configured to provide power to the tow line winch 560 and/or to at least one device on the support float 540. The communication cable 570 can provide communication and control capabilities between the marine survey vessel and the rigid structure 536 and the support float 540 via the umbilical 532. For example, the communication cable 570 can include metal wire or fiber optic components to facilitate transfer of communication and control signals. The communication cable 570 can facilitate communication and control over the tow line winch 560, the support float 540 (and components thereof), and the rigid structure 536 itself. For example, the communication cable 570 can be used to control steerable portions of the rigid structure as described in more detail with respect to FIGS. 7-8.

FIG. 6 is a perspective view of an example of a portion of a rigid structure 636. A marine survey apparatus can include a plurality of seismic source element modules 648-1, 648-2, 648-3 each including a seismic source element 650-1, 650-2, 650-3. The marine survey apparatus can include a plurality of spacer modules 652-1, 652-2 each having a hydrofoil shape and, at a first end, being coupled to a respective first one of the plurality of seismic source element modules 648-1, and, at a second end, being coupled to a respective second one of the plurality of seismic source element modules 648-2. The seismic source element modules 648 and the spacer modules 652 can collectively form the rigid structure 636.

The marine survey apparatus can include a first seismic source element module 648-1 including a first seismic source element 650-1, a second seismic source element module 648-2 including a second seismic source element 650-2, and a hydrofoil shaped member (which can also be represented by numeral 652-1) coupled between the first seismic source element module 648-1 and the second seismic source element module 648-2, collectively forming a rigid structure 636. The hydrofoil shaped member can be coupled to the first seismic source element module 648-1 and to the second seismic source element module 648-2. Alternatively, the hydrofoil shaped member can be coupled to a spar (described in more detail below) that is coupled to the first seismic source element module 648-1 and the second seismic source element module 648-2. In at least one embodiment, the hydrofoil shaped member is not directly coupled to the first seismic source element module 648-1, is not directly connected to the second seismic source element module 648-2, or is not directly connected to either of the first or the second seismic source element modules 648-1, 648-2.

The marine survey apparatus can further include a third seismic source element module 648-3 including a third seismic source element 650-3. The marine survey apparatus can further include a different hydrofoil shaped member (which can also be represented by numeral 652-2) coupled between the second seismic source element module 648-2 and the third seismic source element module 648-3. The first, the second, and the third seismic source element modules 648-1, 648-2, 648-3, the hydrofoil shaped member 652-1, and the different hydrofoil shaped member 652-2 can collectively form the rigid structure 636. The different hydrofoil shaped member can be coupled to the spar and to the second and the third seismic source element modules via the spar. Alternatively, the marine survey apparatus can further include a different spar coupled to and between the second and the third seismic source element modules, where the third seismic source element module is coupled to the different spar and to the second seismic source element module via the different spar. In at least one embodiment, the spar can be coupled to the different spar. For example, different spars can be coupled to each other axially, effectively forming a continuous, longer spar. Embodiments are not limited to a particular number of seismic source element modules or hydrofoil shaped members.

The rigid structure 636 can include a hollow channel 679 internal thereto that runs along a length of the rigid structure 636 and that is defined by respective surfaces in each of the seismic source element modules 648 and the spacer modules 652. In at least one embodiment, the surfaces can include solid surfaces. Although not illustrated in FIG. 6, at least one of the air cable, power cable, and communication cable can run through the hollow channel 679. In at least one embodiment, the hollow channel 679 can be a hollow spar running along a length of the rigid structure 636. In at least one embodiment, the hollow channel 679 can include a solid spar running therein along a length of the rigid structure 636 to provide additional strength to the rigid structure 636.

The spacer modules 652 can have a continuous hydrofoil shape around an exterior of the spacer modules 652 defined by a skin of the spacer module. The skin can be composite, such as fiberglass, metal, or another material. An interior of the spacer modules 652 can be generally hollow, generally solid, honeycomb, or have other interior arrangements to support the exterior skin of the spacer modules 652 and to maintain the hydrofoil shape under pressure imposed by the fluid medium. For embodiments in which the interior of the spacer modules 652 is generally hollow, it can include solid surfaces defining a hollow spar as a component of or corresponding to the hollow channel 679 that runs through the rigid structure 636. For embodiments in which the interior of the spacer modules 652 is generally solid, it can include a hollow channel therethrough as a component of or corresponding to the hollow channel 679 that runs through the rigid structure 636. For embodiments in which the interior of the spacer modules 652 is honeycomb or another interior arrangement, it can include a hollow channel therethrough as a component of or corresponding to the hollow channel 679 that runs through the rigid structure 636.

In at least one embodiment, as illustrated, the seismic source element modules 648 do not have an exterior skin, but rather have an open truss structure that supports the seismic source elements 650 and provides for coupling of the seismic source element modules 648 to adjacent spacer modules 652. As may be observed from FIG. 6, the open truss of the seismic source element modules 648 can be generally planar and arranged to be in-line with a chord line of the spacer modules 652. The chord line is an imaginary line running from a leading edge of the spacer modules 652 to a trailing edge of the spacer modules 652. For those embodiments in which the hydrofoil shape of the spacer modules 652 is symmetric, the chord line is a straight (rather than curved) line. A symmetric hydrofoil shape can be desirable for the spacer modules 652 so as not to generate a force (e.g., lift) transverse to the direction in which the rigid structure 636 is towed while the leading edge of the airfoil shape of the spacer modules 652 is pointed in the direction of tow (at zero angle of attack).

The seismic source element modules 648 and the spacer modules 652 can be individually attachable and removable from one another such that the rigid structure 636 is considered to be modular. In at least one embodiment, the seismic source element modules 648 and the spacer modules 652 can be coupled to each other via the hollow channel 679, for example, where the hollow channel 679 comprises a hollow spar, or where the hollow channel 679 includes a solid spar therein. The seismic source element modules 648 and the spacer modules 652 can have openings that individually slide onto the hollow channel 679, where the hollow channel comprises a continuous body. In such embodiments, the seismic source element modules 648 and the spacer modules 652 can be affixed to the spar mechanically or chemically. Examples of mechanical fixing include welding, nailing, and bolting, among others. An example of chemical fixing includes the use of adhesives.

However, in at least one embodiment, the hollow channel 679 is defined by openings in each of the seismic source element modules 648 and the spacer modules 652, where the hollow channel 679 is not a continuous body separate from the openings in the seismic source element modules 648 and the spacer modules 652. In such embodiments, the seismic source element modules 648 and the spacer modules 652 can be coupled to each other mechanically or chemically.

As illustrated, the seismic source element modules 648 can each include a module air cable 681-1, 681-2, 681-3 coupled to a respective seismic source element 650. The module air cable 681 can also be coupled to the air cable that runs from the umbilical to the rigid structure 636 (the air cable 568 illustrated in FIG. 5). For example, the air cable can run through the hollow channel 679 and couple to the module air cables 681 via openings through the solid surface that defines the hollow channel 679.

FIG. 7 is a cross section of an example of a spacer module 750 with a hinged trailing edge 780. The spacer module 750 can have a hydrofoil shape such as, for example, the one illustrated by the cross section shown in FIG. 7. Also illustrated in the spacer module 750 is the hollow channel 779. The hinged trailing edge 780 of the spacer module 750 can operate as a rudder for the spacer module 750 and thus for the rigid structure to steer the rigid structure as it is towed. In at least one embodiment, the hinged trailing edge 780 can be operated by powering a servo (not specifically illustrated) attached to the hinged trailing edge 780. Power can be provided to the servo via the power cable (e.g., power cable 566 illustrated in FIG. 5) from the umbilical. For those embodiments that include a spacer module 750 with a hinged trailing edge 780, one or more of the spacer modules 750 of the rigid structure can include a hinged trailing edge 780.

FIG. 8A is a cross section of an example of a spacer module 850 with tow line attachment points 882-1, 882-2. FIG. 8B is a cross section of an example of a spacer module 850 with a tow line attachment point 882. Also illustrated in the spacer module 850 is the hollow channel 879. The tow line attachment points 882 can be formed in material extending from opposite sides of an exterior of the spacer module 850. For example, the material can extend either from opposite side of the hydrofoil shape of the spacer module 850 in directions perpendicular to the chord line of the hydrofoil shape as shown in FIG. 8A, or as single points oriented forward from a leading edge of the hydrofoil shape as shown in FIG. 8B. The material can be composite, metal, or another material. A pair of tow lines 834-X, 834-Y can be coupled to the tow line attachment points 882 as illustrated in FIG. 8A. Although the previous figures herein illustrated only one tow line being attached to each spacer module, embodiments are not so limited. As illustrated in FIG. 8A, two (or more) tow lines 834 can be attached to a spacer module 850. Differential tension can be applied between the tow line attachment points 882 via the pair of tow lines 834 to cause the spacer module 850 to rotate while being towed. Such rotation can cause the leading edge of the spacer module 850 to have a non-zero angle of attack, which can generate a force (e.g., lift) in a direction transverse to the direction in which the spacer module 850 is being towed. Such force can help steer the spacer module 850 and thus the rigid structure. For example, an improved ability to steer the rigid structure can be beneficial in providing separation forces between different rigid structures in a source array (see FIG. 3). For those embodiments that include a spacer module 850 with tow line attachment points 882, one or more of the spacer modules 850 of the rigid structure can include tow line attachment points 882. In at least one embodiment, a rigid structure can include a first spacer module having a hinged trailing edge (as illustrated in FIG. 7) and a second spacer module 850 having tow line attachment points 882. Other arrangements for alteration of the hydrofoil shape and/or angle of attack for steering purposes can be used.

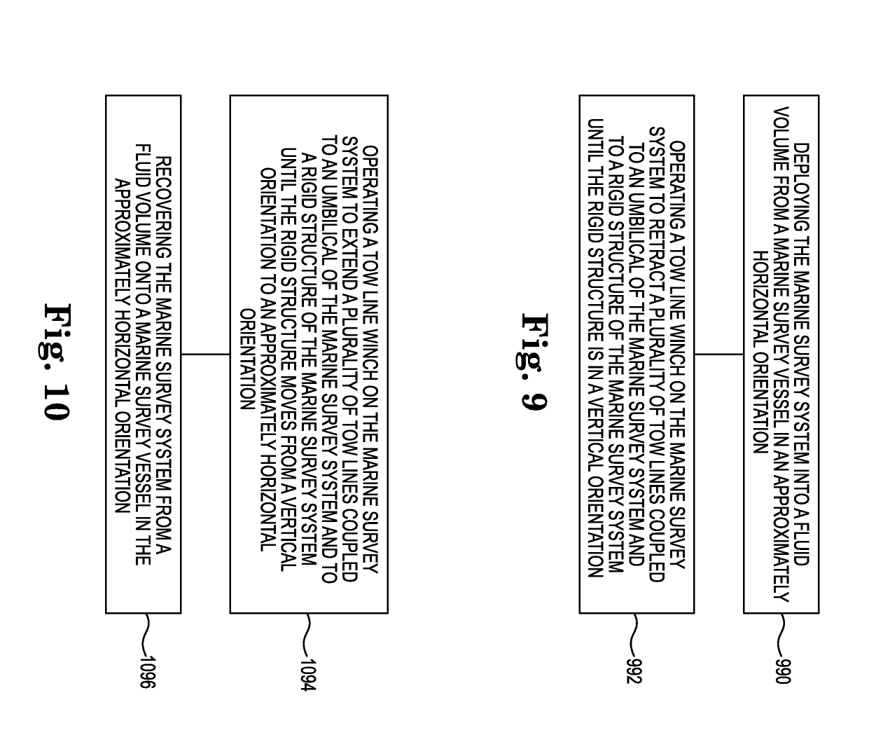

FIG. 9 is a flow chart illustrating an example of a method for deploying a marine survey system. At 990 the method can include deploying the marine survey system into a fluid volume from a marine survey vessel in an approximately horizontal orientation, such as is illustrated in FIG. 5. At 992, the method can include operating a tow line winch on the marine survey system to retract a plurality of tow lines coupled to an umbilical of the marine survey system and to a rigid structure of the marine survey system until the rigid structure is in a vertical orientation. Operating the tow line winch can include powering the tow line winch via the umbilical. The method can include adjusting a depth of the rigid structure via operation of a depth control device on a support float coupled to the rigid structure. The method can include steering the rigid structure by operation of a position control device on the support float. The method can include powering the depth control device and the position control device via the umbilical. The method can include steering the rigid structure by applying differential tension to a pair of tow lines coupled to opposite sides of the rigid structure. The method can include steering the rigid structure via operation of a hinged trailing edge of at least a portion of the rigid structure.

FIG. 10 is a flow chart illustrating an example of a method for recovering a marine survey system. At 1094, the method can include operating a tow line winch on the marine survey system to extend a plurality of tow lines coupled to an umbilical of the marine survey system and to a rigid structure of the marine survey system until the rigid structure moves from a vertical orientation to an approximately horizontal orientation. At 1096, the method can include recovering the marine survey system from a fluid volume onto a marine survey vessel in the approximately horizontal orientation. Recovering the marine survey system can comprise retracting the umbilical onto the marine survey vessel.

In accordance with a number of embodiments of the present disclosure, a geophysical data product may be produced. The geophysical data product may include, for example, field data recorded during a survey utilizing the above-described techniques. Geophysical data may be obtained and stored on a non-transitory, tangible computer-readable medium. In some instances, geophysical analysis may be performed on the geophysical data product offshore according to techniques described herein or known in the art, and stored on a computer-readable medium, to produce an enhanced geophysical data product.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A marine survey apparatus, comprising:
a plurality of seismic source element modules each including a seismic source element; and
a plurality of spacer modules each having a hydrofoil shape and, at a first end, being coupled to a respective first one of the plurality of seismic source element modules and, at a second end, being coupled to a respective second one of the plurality of seismic source element modules;
wherein the plurality of source element modules and the plurality of spacer modules collectively form a rigid structure.

2. The marine survey apparatus of claim 1, further comprising a tow line winch module coupled to the rigid structure, the tow line winch module including a tow line winch.

3. The marine survey apparatus of claim 1, wherein an end of the rigid structure further includes a support attachment point configured to be coupled to a line from a support float.

4. The marine survey apparatus of claim 3, wherein an opposite end of the rigid structure is configured to be coupled to an umbilical from a marine survey vessel; and
wherein the opposite end includes an opening configured to receive a power cable, an air cable, and a communication cable from the umbilical.

5. The marine survey apparatus of claim 4, further comprising a hollow channel internal to the rigid structure that runs along a length of the rigid structure and that is defined by respective solid surfaces in each of the plurality of spacer modules and the plurality of seismic source element modules.

6. The marine survey apparatus of claim 1, wherein at least one of the plurality of spacer modules includes a tow line attachment point oriented forward from a leading edge of the hydrofoil shape to an exterior of the at least one spacer module.

7. The marine survey apparatus of claim 1, wherein at least one of the plurality of spacer modules includes a pair of tow line attachment points on opposite sides of an exterior of the at least one spacer module such that differential tension between the pair of tow line attachment points causes the at least one spacer module to rotate while being towed.

8. The marine survey apparatus of claim 1, wherein at least one of the plurality of spacer modules includes a hinged trailing edge configured to operate as a rudder.

9. The marine survey apparatus of claim 1, wherein the plurality of spacer modules and the plurality of seismic source element modules are individually attachable and removable from one another.

10. A marine survey system, comprising:
a rigid structure including:
a plurality of spacer modules each having a hydrofoil shape; and
a plurality of seismic source element modules each coupled to at least one of the plurality of spacer modules;
a tow line winch coupled to the rigid structure and to a plurality of tow lines such that operation of the tow line winch changes an amount by which the plurality of tow lines are extended to change an orientation of the rigid structure between vertical and approximately horizontal;
a support float coupled to a first end of the rigid structure; and
an umbilical coupled to the rigid structure, wherein the umbilical includes a bridle coupled to the plurality of tow lines, and wherein the umbilical includes a power cable coupled to the tow line winch.

11. The marine survey system of claim 10, wherein the umbilical is coupled to a second end of the rigid structure.

12. The marine survey system of claim 10, wherein the tow line winch and the plurality of tow lines are configured such that operation of the tow line winch to increase the amount by which the plurality of tow lines are extended changes the orientation of the rigid structure away from vertical and toward horizontal.

13. The marine survey system of claim 10, wherein the tow line winch and the plurality of tow lines are configured such that operation of the tow line winch to decrease the amount by which the plurality of tow lines are extended changes the orientation of the rigid structure away from horizontal and toward vertical.

14. The marine survey system of claim 10, wherein the plurality of tow lines are coupled to the tow line which through a corresponding plurality of openings in the rigid structure.

15. The marine survey system of claim 10, wherein the umbilical includes an air cable coupled to a plurality of seismic source elements in the plurality of seismic source element modules.

16. The marine survey system of claim 10, wherein the support float includes a depth control device coupled to the rigid structure and configured to control a depth of the rigid structure; and
wherein the power cable or a different power cable from the umbilical is coupled to and configured to provide power to the depth control device.

17. The marine survey system of claim 10, wherein the support float includes a position control device; and
wherein the power cable or a different power cable from the umbilical is coupled to and configured to provide power to the position control device.

18. The marine survey system of claim 10, wherein an end of the umbilical coupled to the second end of the rigid structure is sufficiently heavy to urge the second end of the rigid structure to remain vertically below the support float while being towed at marine survey speeds.

19. A method for deploying a marine survey system, comprising:
deploying the marine survey system into a fluid volume from a marine survey vessel in an approximately horizontal orientation; and
operating a tow line winch on the marine survey system to retract a plurality of tow lines coupled to an umbilical of the marine survey system and to a rigid structure of the marine survey system until the rigid structure is in a vertical orientation.

20. The method of claim 19, wherein operating the tow line winch includes powering the tow winch via the umbilical.

21. The method of claim 19, wherein the method further includes adjusting a depth of the rigid structure via operation of a depth control device on a support float coupled to the rigid structure.

22. The method of claim 21, wherein the method further includes steering the rigid structure by operation of a position control device on the support float.

23. The method of claim 22, wherein the method further includes powering the depth control device and the position control device via the umbilical.

24. The method of claim 19, wherein the method further includes steering the rigid structure by applying differential tension to a pair of tow lines coupled to opposite sides of the rigid structure.

25. The method of claim 19, wherein the method further includes steering the rigid structure via operation of a hinged trailing edge of at least a portion of the rigid structure.

26. A method for recovering a marine survey system, comprising:
operating a tow line winch on the marine survey system to extend a plurality of tow lines coupled to an umbilical of the marine survey system and to a rigid structure of the marine survey system until the rigid structure moves from a vertical orientation to an approximately horizontal orientation; and
recovering the marine survey system from a fluid volume onto a marine survey vessel in the approximately horizontal orientation.

27. The method of claim 26, wherein recovering the marine survey system comprises retracting the umbilical.

28. A marine survey apparatus, comprising:
a first seismic source element module including a first seismic source element;
a second seismic source element module including a second seismic source element; and
a hydrofoil shaped member coupled between the first and the second seismic source element modules;
wherein the first and the second seismic source element modules and the hydrofoil shaped member collectively form a rigid structure.

29. The marine survey apparatus of claim 28, wherein the hydrofoil shaped member is coupled to the first and the second seismic source element modules.

30. The marine survey apparatus of claim 28, further including a spar coupled to and between the first and the second seismic source element modules;
wherein the hydrofoil shaped member is coupled to the spar.

31. The marine survey apparatus of claim 30, wherein the hydrofoil shaped member is not directly connected to the first seismic source element module.

32. The marine survey apparatus of claim 30, further including:
a third seismic source element module including a third seismic source element; and
a different hydrofoil shaped member coupled between the second and the third seismic source element modules;
wherein the first, the second, and the third seismic source element modules, the hydrofoil shaped member, and the different hydrofoil shaped member collectively form a rigid structure.

33. The marine survey apparatus of claim 32, wherein the different hydrofoil shaped member is coupled to the spar and to the second and the third seismic source element modules via the spar.

34. The marine survey apparatus of claim 32, further including a different spar coupled to and between the second and the third seismic source element modules;
wherein the third seismic source element module is coupled to the different spar and to the second seismic source element module via the different spar.

35. The marine survey apparatus of claim 34, wherein the spar is coupled to the different spar.
